(19) United States
(12) Patent Application Publication
(10) Pub. No.: US 2005/0273650 A1
(43) Pub. Date: Dec. 8, 2005

(54) Systems and methods for backing up computer data to disk medium

(76) Inventor: Henry Horngren Tsou, San Jose, CA (US)

Correspondence Address: Henry H. Tsou, 6835 Tunbridge Way, San Jose, CA, 95120, US

(21) Appl. No.: 10/862,140

(22) Filed: Jun. 7, 2004

(51) Int. Cl. G06F 12/16

(52) U.S. Cl. 714/6; 711/162; 711/112

(57) ABSTRACT

Data Protection on computer data is to insure data availability. The mission critical data has been chronically stored and labeled with version, distinguished in time of stored. In order to save storage of a backup medium, one full backup is stored and then is followed by many differential or incremental backups. The disclosed employs a Direct Access Storage Device (DASD or disk) as a backup medium. Disk provides a memory model with (1) random access attribute and (2) flat address space. Therefore data restoration for a given version can be achieved by an intelligent backup disk device rather than by a backup server. Intelligent backup disk device compares backup data between different versions and eliminates redundant backup data in later version. Presently backup server performs all data protection functions that include data backup and data restoration. An intelligent primary disk device, where the primary data resides, is capable to record all write operations on a write journal continuously between the previous backup and the ensuing backup. Once a backup is requested, the primary intelligent disk device retrieves write data from its disk medium and transfers the write data along with the write journal to the intelligent backup disk device where the second copy is stored. The intelligent primary disk device and the intelligent backup disk device concertedly perform data protection functions. Furthermore, these data protection functions can be located at a SAN (Storage Area network) switch. The switch becomes the center of data protection in networked computer configuration.

### FIELD OF THE INVENTION

This invention relates to system and method to perform computer data backup and restoration and, more particularly to use Direct Access Storage Device (DASD) as a backup medium for computer data backup and restoration.

### DESCRIPTION OF THE RELATED ART

Making backup copies of important computer data to another medium is an imperative task. The computer primary data is largely stored in DASD device (Direct Access Storage Device or disk for short). Disk provides fast access for data and has characteristic of no volatile memory. There are reasons to back up computer disk data (disk image or files). One of reasons is to prevent data loss from disk hardware failure. Even the disk technology advances; the probability of disk hardware failure cannot be ignored. The second reason is to recover the disk data when a disastrous event happens at the surrounding of the computer disk and the computer disk can render not operational in the event. The third reason is to retrieve the last backup version of data in case that computer user requests to do so. The forth reason is to keep different versions of the same files as time progresses. There are requirements for computer users to retrieve files chronologically.

Data Protection on computer data is to insure data availability. Data protection hereto is to backup computer data and to restore the user data upon request. There can be many versions, distinguished in time of stored, of the same disk data (disk image or files). The common computer systems typically include one or many storage devices. The storage devices are disk devices, tape drives, optical drives, etc. The enterprise systems employ disk arrays, automated tape libraries, optical drives, etc. There is at least one data backup server that executes storage management software to perform data backup and data restoration for computer system. The modern computer systems adopt network architecture; general-purpose server, backup server, disk arrays, and automated tape library are communicating through a computer network. FIG. 1 shows a modern computer system that is based on network architecture.

Backup server performs data protection functions. There are three data backup methods (i.e. full backup, differential backup and incremental backup) and two backup techniques (i.e. image backup technique, and file-by-file backup technique) that are commonly adopted.

The file-by-file technique in full backup is a very time consuming task due to file allocations on the physical sectors of the disk are not sequential. There are too many recording head movements and too many wastes in disk rotations. The file system involving in file open and disk reading makes response time worse. In many occasions, even the backup tape drive that employs speed-matching buffer has to stop and re-start the tape recording. The file-by-file full backup for a network storage takes hours. However differential backup (backing up the differences from the time of the last full backup to this moment) or incremental backup (backing up the differences from the last backup (either full backup or earlier incremental backup) to this moment) can be easily performed due to that a ratio of updated files to total files in a disk volume is relatively low. A common practice is to perform full backup once a week and incremental or differential backup once per day. Full backups still need to be performed fairly regularly, because restoring the file contents from a full backup and a large set of incremental backups can be very time consuming. It is also true for differential backup because the cumulative backup data is growing rapidly as time progresses.

The other technique, image backup technique, backs up disk partition images of a disk. Image full backup takes advantage of disk sequential read operations and solves the problem of file-by-file full backup. A drawback of image backup is requiring an equal or greater storage space in the backup medium than the real data in the disk that to be backed up. There is a waste in the backup medium if the disk utilization rate is low. Another disadvantage of traditional image backup is not supporting differential backup or incremental backup. The most operating systems maintain an archive bit in the file to indicate whether the file has been updated or not. Application software can figure out the physical location of the updated file but does not have knowledge to trace back other components that link the updated file to the rest of partition image in order to maintain full disk partition image. Therefore, differential or incremental backup cannot be done in image backup technique.

In U.S Pat. No 5,907,672, John E. G. Matze et al disclose System for backing up computer disk volumes. Matze et al teach a method to perform an incremental backup by using a resident software module, that is running all the time in server platform, to monitor which parts of the disk volume have been updated. This allows incremental backup to take place only updated parts of the disk partition. Their technique only applies to systems that execute backup software in server platforms. This also impacts system performance.

In U.S Pat. No. 6,542,975, Evers D. L. et al disclose Method and system for backing up data over a plurality of volumes. Evers D. L. et al teach a method to replicate a disk partition by copying many data chunks to a backup medium. Each data chunk associates with one data chunk descriptor that specifies the location of data in the partition image. Restoring partition image is to move the stored data chunks to the right locations of a temporary storage. This method only applies to full backup of a disk partition and is not applicable to incremental backup.

IBM's Tivoli Storage Manager organizes backup storage with hierarchical structure. The Storage Manager moves backup data from one storage hierarchy level to other. The function is used to cache backup data onto a disk before moving the data to tape cartridges. The management database, that tracks relationship between locations of backup data on the backup medium and locations of backed up data on the originating disk partition, is stored within the backup server's on-line storage. Tivoli Storage Manager or other commercial storage management software generates a lot of network traffic and do not have centralized repository for management database and backup data.

FIG. 2 shows network traffic for a modern computer system that employs a cache disk for data backup.

In any backup techniques, either image technique or file-by-file technique, there are many redundant backup data stored on backup disk device. Without management database and backup data stored at a centralized repository, tasks to reduce the redundant backup data are slow and snarls network traffic. An intelligent apparatus, that is devised to eliminate redundant backup data in a very efficient way, will be addressed in the present invention.

The deficiencies are clearly felt in the art and are resolved by this invention in the manner described below.

### SUMMARY OF THE INVENTION

The present invention provides methods and systems for backing up and restoring computer data to and from a backup disk device. The goals of the present invention are (1) eliminating performance degradation from resident software module that monitors image update at all time in image backup technique (2) resolving lacking of incremental backup supports from image backup technique or data chunk backup in the prior art (3) resolving lacking of centralized repository for backup data and management database (4) reducing redundant backup data in backup medium (5) significantly alleviating network traffic during data backup and data restoration (6) lowering overall cost by adopting new methods and systems.

The systems in this invention employ disk device as the backup medium. As present time, cost per gigabyte storage for disk drive and tape cartridge are comparable. Disk device offers higher data transfer rate, random access attribute, and flat memory space. Backup disk device maintains management database, the database that tracks locations of backup data on its medium and locations of backed up data on the primary disk device, as well as stores backup data. With availability of management database and backup data, the processor in the backup disk device can restore the stored disk partition image in image backup technique. The restored disk image can be mounted as a read-only volume directly from the backup disk device. The processor in the backup disk device also can reduce or eliminate redundant backup data in backup disk device in either image backup technique or file-by-file backup technique. The backup disk device, that is capable to perform the above functions, is called intelligent backup disk device hereto.

A disk device, whose data to be stored onto a backup medium, is a primary disk device. Primary disk device is continuously maintaining a write journal, collections of write operations. A primary disk device, that is capable of transferring backup identification, write record, and backup data to a backup medium, is called intelligent primary disk device. Write record is a form of write journal at time of stored. The intelligent primary disk device performs full backup or differential backup, incremental backup, and standalone backup upon request.

With intelligent primary disk device and intelligent backup disk device, roles of backup server, functions of storage management software, and network traffic in performing storage management are drastically reduced. The overall cost to perform date protection is also lowered.

### BRIEF DESCRIPTION OF THE DRAWING

FIG. 1 shows a modern computer system that is based on network architecture.

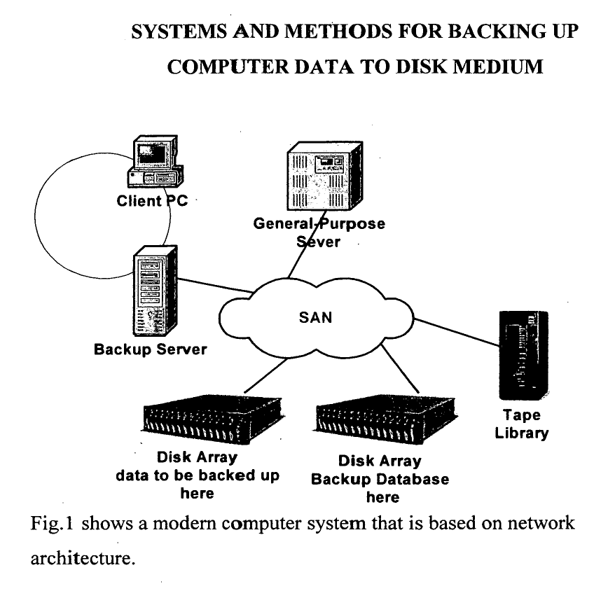

FIG. 2 shows network traffic for a modern computer system that employs a cache disk for data backup.

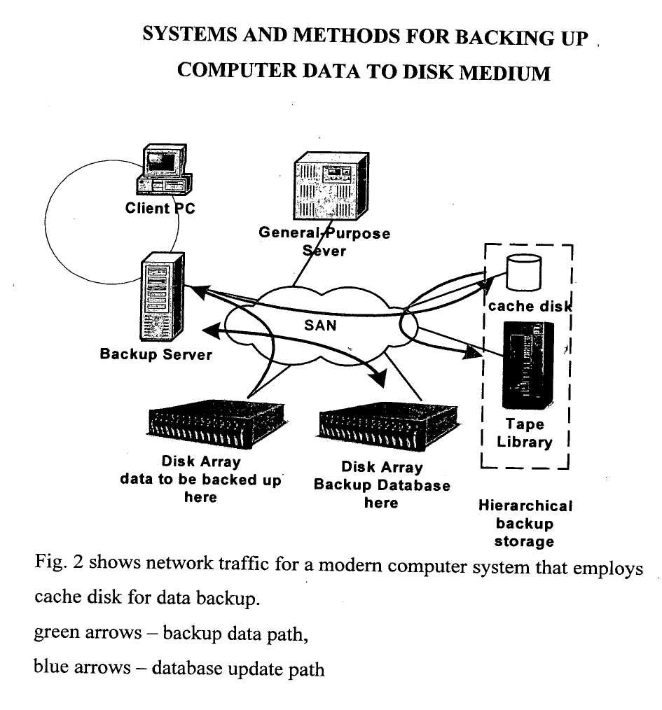

FIG. 3 shows an exemplary computer system including general-purpose server, management station, intelligent primary disk device, and intelligent backup disk device.

FIG. 4 shows an exemplary computer system including general-purpose server, management station, local disk storage pertained to management station, intelligent primary storage controller, primary disk medium, intelligent backup storage controller, and backup disk medium.

### DETAILED DESCRIPTION OF THE PREFERRED EMBODIMENT

With intelligent primary disk device and intelligent backup disk device, roles of backup server and functions of storage management software are drastically reduced. In fact, a personal computer (PC) can replace backup server and the PC is the management station to initiate backup operation.

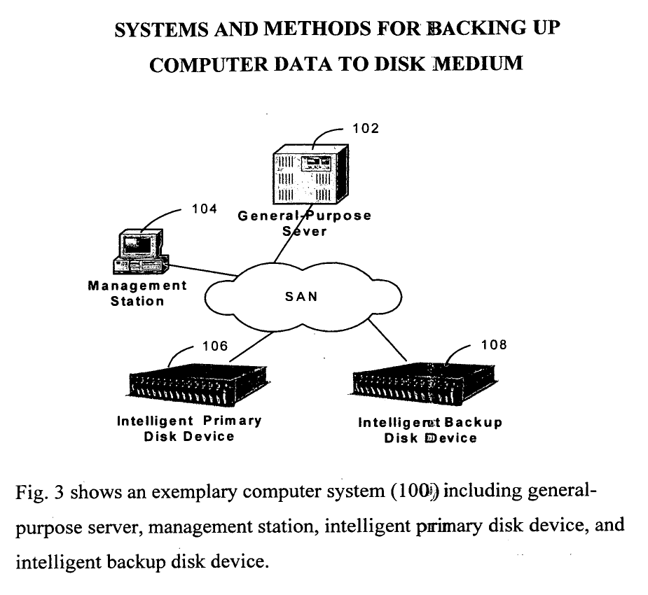

FIG. 3 shows an exemplary computer system 100 including the general-purpose server 102, the management station 104, the intelligent primary disk device 106 that may have multiple LUNs (Logical Unit Numbers, LUN 2 is used for illustrative examples), and the intelligent backup disk device 108 whose capacity is much bigger that device 106.

The first illustrative example is for a configuration having single partition on LUN 2 of device 106. The management station 104 issues a backup identification command along with a backup identification construct to the intelligent primary disk device 106. The management station 104 also issues a backup identification command along with a backup identification construct to the intelligent backup disk device 108. This signals the birth of backup session. The backup identification construct contains (1) Target identification—the unique identification of the device 106, (2) Logical Unit Number—LUN 2, (3) scope of backup—from LBA (logical Block Address) 0 to maximum LBA of LUN 2 in the device 106, and (4) granular unit of backup data in sectors—is a user's choice (one sector or multiple sectors). The communication between management station 104 and device 106 and the communication between management station 104 and device 108 can be through either in-band connection (normal data exchange path) or out-band connection.

Next step is to perform a full backup. The management station 104 issues a backup command along with a full backup construct to the device 106. The full backup construct contains (1) Target identification, (2) LUN number, (3) scope of backup (4) version—a unique number or time of storing this backup data, (5) package type—full backup package type (6) write record—describe how many sectors in the device 106 have to be transferred to the device 108 and locations of those sectors in the device 106. The device 106 processes this command and transfers the above information, item (1) through item (6) of the full backup construct, and the backup data, the item (7), to the device 108.

The write record contains (1) write record header and (2) write descriptive block instances.

The write record header contains (1) number of write descriptive block instances—one instance of write descriptive block for this illustrative example and (2) total number of backup sectors in the write record—capacity in sector of the LUN 2 for this illustrative example.

The write descriptive block includes (1) starting LBA of backup—zero (the first LBA of LUN2), (2) ending LBA of backup—maximum LBA of the LUN 2, (3) number of backup sectors in the write descriptive block—capacity in sector of the LUN 2, (4) granularity of bit map—64 sectors (user's choice), and (5) backup bit map—omitted for this illustrative example. The meaning of the backup bit map will be explained in a later paragraph.

In this illustrative example, the first example of the present invention, the full backup is to copy the whole image of the LUN 2 of device 106 to the device 108. Device 106, upon receiving the backup command from management station 104, sends the full backup construct and data of full volume of LUN2 of device 106 to device 108.

In the second illustrative example, the management station 104 examines the FAT (File Allocation Table) table in the LUN 2 and finds that the first 1000 clusters are used and the rest of capacity is unused. Cluster is the smallest recording unit in a file system. 64 sectors per cluster is for this illustrative example. The differences between the first illustrative example and the second illustrative example are (1) content of the write record and (2) backup data—every sector in the LUN 2 has to be backed up in the first illustrated example versus 64,000 (64×1000) sectors of data have to be backed up in the second illustrated example.

The write record header in the second illustrative example contains (1) number of write descriptive block instances—one for this illustrative example and (2) total number of backup sectors in the write record—64,000 sectors.

The write descriptive block includes (1) starting LBA of backup—zero, (2) ending LBA of backup—63,999, (3) number of backup sectors in the write descriptive block—64,000, (4) granularity of bit map—64 (size of FAT's cluster in sectors), and (5) backup bit map—omitted for this illustrative example.

The second illustrative example has advantage in saving storage space of the device 108 over the first illustrative example. Storing unused sectors is irrelevant. Device 106, upon receiving the backup command from management station 104, sends the full backup construct and data of 64,000 sectors of LUN2 of device 106 to device 108. The full backup construct in the second illustrative example contains (1) Target (Device 106) Identification, (2) Logic Unit Number—LUN 2, (3) scope of backup—from LBA 0 to maximum LBA of LUN 2, (4) version—a unique number or time of storing this backup data, (5) package type—full backup package type (6) write record: (6a) write record header: (6aa) number of write descriptive block instances—one, (6ab) total number of backup—64,000 sectors; (6b) write descriptive block: (6ba) starting LBA of backup—zero, (6bb) ending LBA of backup—63,999, (6bc) number of backup sectors in the write descriptive block—64,000, (6bd) granularity of bit map—64, (6be) backup bit map—omitted for this illustrative example.

In the third illustrative example, the management station 104 examines the FAT table in the LUN 2 and finds that the first 980 clusters and even number of clusters from cluster 40000 to cluster 40039 are used. The total number of used clusters is 1000. The difference between the third illustrative example and the second illustrative example is in the content of write record.

The write record header in the third illustrative example contains (1) number of write descriptive block instances—two for this illustrative example and (2) total number of backup sectors in the write record—64,000 sectors, the same as in the second illustrative example.

The first write descriptive block includes (1) starting LBA of backup—zero, (2) ending LBA of backup—((980×64)−1=) 62,719, (3) number of backup sectors in the write descriptive block—(980×64=) 62,720, (4) granularity of bit map—64, and (5) backup bit map—omitted for this illustrative example.

The second write descriptive block includes (1) starting LBA of backup—(40000×64=) 2,560,000, (2) ending LBA of backup—((40040×64)−1=) 2,562,559, (3) number of backup sectors in the write descriptive block—(20×64=) 1280, (4) granularity of bit map—64, and (5) backup bit map—40 bits (10101010, 10101010, 10101010, 10101010, 10101010 in bitmap). The backup bit map traverses from cluster 40000 to 40039. Each bit represents one cluster. Binary-one value means the cluster is used. Binary-zero value means the cluster is unused. For simplicity and saving storage space, a backup bit map is omitted if all bit positions of the backup bit map contains only binary-one value. In other words, the omission of the backup bit map in a write descriptive block means that all sectors in the region from the starting LBA of backup to the ending LBA of backup of the write descriptive block are used.

The third illustrative example demonstrates a flexibility of write record in the case that plurality (very likely) occurs on the image of the LUN.

The third illustrative example also has advantage in saving storage space of the device 108 over the first illustrative example. Storing unused sectors is irrelevant. Device 106, upon receiving the backup command from management station 104, sends the full backup construct and data of 64,000 sectors of LUN2 of device 106 to device 108. The full backup construct in the third illustrative example contains (1) Target (Device 106) Identification, (2) Logic Unit Number—LUN 2, (3) scope of backup—from LBA 0 to maximum LBA of LUN 2, (4) version—a unique number or time of storing this backup data, (5) package type—full backup package type (6) write record: (6a) write record header: (6aa) number of write descriptive block instances—two, (6ab) total number of backup—64,000 sectors; (6b) write descriptive block 1: (6ba) starting LBA of backup—zero, (6bb) ending LBA of backup—62,719, (6bc) number of backup sectors in the write descriptive block—62,720, (6bd) granularity of bit map—64, (6be) backup bit map—omitted for the write descriptive block 1; (6c) write descriptive block 2: (6ca) starting LBA of backup—2,560,000, (6cb) ending LBA of backup—2,562,559, (6cc) number of backup sectors in the write descriptive block—1,280, (6cd) granularity of bit map—64, (6ce) backup bit map—(1010101010101010101010101010101010101010) for the write descriptive block 2.

In the fourth illustrative example, there are two disk partitions on the LUN. The image of the LUN contains disk partition table, the first partition, and the second partition. The management station 104 makes three backup identification constructs for the LUN. The three backup identification constructs contain same information of (1) Target identification (2) Logical Unit Number. Each backup identification construct has its own backup scope, starting LBA of backup scope and ending LBA of backup scope, and its own granular unit of backup data in sectors. These three backup scopes cover the whole image of the LUN 2 and cannot be overlapped. The management station 104 has to establish three backup sessions individually.

The device 106 processes a full backup command and transfers a full backup package to the device 108. Full backup package includes (1) Target identification, (2) LUN number, (3) scope of backup, (4) version—a unique number or time of storing this backup data, (5) package type—full backup package type (6) write record (7) backup data that is read from the medium of the LUN 2 of the device 106. The device 106 and the device 108 are working on LBA (sector) basis and have no knowledge of FAT or cluster size.

In the fifth illustrative example, the management station 104 issues a differential backup command along with a backup identification construct to the device 106. The device 106 has implemented a write journal. The device 106 resets the write journal when it completes a full backup and is recording every write operation on the write journal since the last full backup. Once a differential backup is requested to the device 106, the device 106 generates a write record based on the information on the write journal. The device 106 assembles a differential backup package and sends the differential backup package to the device 108. The differential backup package contains (1) Target identification, (2) LUN number, (3) scope of backup (4) version—a unique number or time of storing this backup data, (5) package type—differential backup package type, (6) the write record, and (7) backup data—the data that has been updated since the last full backup. The data is read from the medium of LUN 2 of device 106. Besides the management station 104 issues a differential backup command, a pre-set timer (e.g. one event per day) or a pre-set policy (e.g. reach the threshold of write operations) in the device 106 can also issue differential backup requests internally.

In the fifth illustrative example, the device 108 receives the full backup package and the differential backup package. The device 108 stores the backup data and maintains relationship between locations of backup data on the device 108 and locations of backed up data on the device 106 in accordance to the information in the backup package into the management database. The device 108 repeats the same task for the full backup package and the differential backup package. If data restoration is requested, the device 108 reconstructs a versioned (time of stored) image of disk partition based on the information in management database and backup data. The management station 104 mounts a drive that represents a version of saved partition image.

The device 108 performs redundant backup data elimination. The device 108 traverses and compares each granular unit of the backup data in the write descriptive blocks of the differential backup package and the backup data in the earlier full backup package. If comparison yields equal result, the backup data of that granular unit in the differential backup package is deemed void. The feature of the redundant backup data elimination saves the device 108's storage and saves the data entry of the management database. Device 106 maintains write journal, that records the write operations have been done on the medium, but does not know whether the new data on the medium differs from old data on the medium.

Redundant backup data elimination can also be taken place after completing updating the management database upon receiving differential backup package. The device 108 traverses the new entries, which based on the newly incoming differential backup package, and compares the new backup data against the earlier backup data. If comparison yields equal result, the granular unit of new backup data and new entry to management database are eliminated.

The management database in the device 108 is paramountly critical. Loss of management database is unacceptable. Data mirroring or other RAID (Redundant Array Inexpensive Disks) scheme is recommended to protest management database.

In the sixth illustrative example, the management station 104 issues an incremental backup command along with a backup identification construct to device 106. The device 106 has implemented a write journal. The device 106 resets the write journal when it completes the last backup and is recording every write operation on the write journal since the last backup. Once an incremental backup is requested to the device 106, the device 106 generates a write record based on the information on the write journal. The device 106 assembles an incremental backup package and sends the incremental backup package to the device 108. The incremental backup package contains (1) Target identification, (2) LUN number, (3) scope of backup (4) version—a unique number or time of storing this backup data, (5) package type—incremental backup package type, (6) the write record, and (7) backup data—the data that has been updated since the last backup. The data is read from the medium of the LUN 2 of the device 106. Besides the management station 104 issues a incremental backup command, a pre-set timer (e.g. one event per day) or a pre-set policy (e.g. reach the threshold of write operations) in the device 106 can also issue incremental backup requests internally

In the sixth illustrative example, the device 108 receives the full backup package and a sequence of incremental backup packages. The device 108 stores the backup data and maintains relationship between locations of backup data on the device 108 and locations of backed up data on the device 106 in accordance to the information in the backup package into the management database. The device 108 repeats the same task for the full backup package and every incremental backup package. If data restoration is requested, the device 108 reconstructs a versioned image of disk partition based on the information in management database and backup data. The management station 104 mounts a drive that represents a version of saved partition image.

The device 108 performs redundant backup data elimination. The device 108 traverses and compares each granular unit of the backup data in the write descriptive blocks of the incremental backup package and the backup data in a earlier backup package. If comparison yields equal result, the backup data of that granular unit in the incremental backup package is deemed void. The feature of the redundant backup data elimination saves the device 108's storage and saves the data entry of the management database. Device 106 maintains write journal, that records the write operations have been done on the medium, but does not know whether the new data on the medium differs from old data on the medium.

Redundant backup data elimination can also be taken place after completing updating the management database upon receiving incremental backup package. The device 108 traverses the new entries, which based on the newly incoming incremental backup package, and compares the new backup data against the earlier backup data. If comparison yields equal result, the granular unit of new backup data and new entry to management database are eliminated.

The management database in the device 108 is critical. Loss of management database is unacceptable. Data mirroring or other RAID scheme is recommended to protest management database.

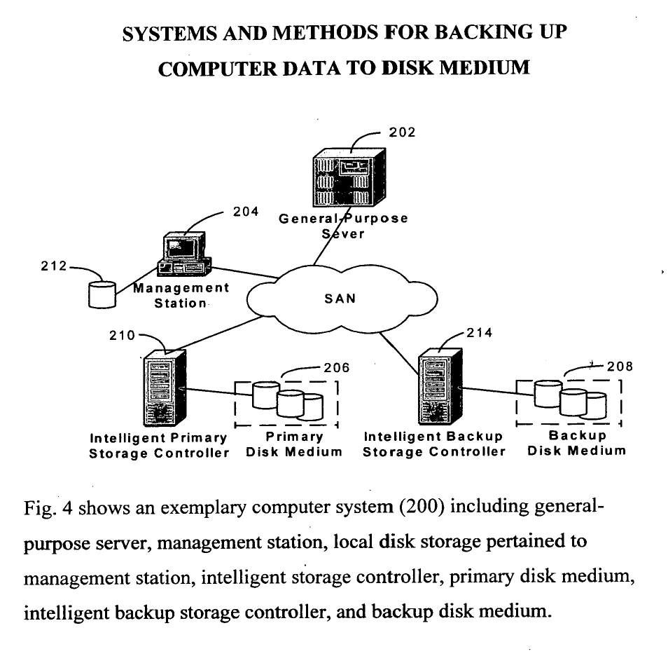

FIG. 4 shows an exemplary computer system 200 including the general-purpose server 202, the management station 204, the local disk storage 212 pertained to the management station 204, the intelligent primary storage controller 210, the primary disk medium 206 that having multiple LUN (LUN 2 is used for illustrative examples), the intelligent backup storage controller device 214, and the backup disk medium 208 whose capacity is much bigger that device 206 or storage 212.

In the seventh illustrative example, the intelligent storage controller 210 can perform the functions of device 106 in FIG. 3. The intelligent primary storage controller 210 is maintaining the write journal, reads backup data from the device 206, and produces backup packages (full backup type or differential backup type or incremental backup type) upon requests. The intelligent storage controller 210 then transfers the backup packages to the device 214. The device 214 stores backup data onto device 208. The device 214 records locations of backup data that is stored at device 208 and locations of backed up data that is resided at the device 206 to management database. The management database is also stored at the device 208. The intelligent backup storage controller 214 reconstructs the stored image upon request.

The device 214 performs redundant backup data elimination. The device 108 traverses and compares each granular unit of the backup data in the write descriptive blocks of the differential backup package and the backup data in the earlier full backup package. If comparison yields equal result, the backup data of that granular unit in the differential backup package is deemed void. The feature of the redundant backup data elimination saves the device 208's storage and saves the data entry of the management database. Device 210 maintains write journal, that records the write operations have been done on the medium, but does not know whether the new data on the medium differs from old data on the medium.

The device 214 also performs redundant backup data elimination for the incremental backup packages. Data mirroring or other RAID scheme is recommended to protest management database.

In the eighth illustrative example, the management station 204 produces backup packages based on a partition image of device 206 or a partition image of the storage 212. The management station 204 sends the backup packages to the device 214. The functions of device 214 have been stated in the above paragraphs

Furthermore the functions of the intelligent primary storage controller can be implemented in a SAN (Storage Area Network) switch. The switch becomes the intelligent primary storage switch. The functions of the intelligent backup storage controller can be implemented in a SAN switch. The switch port becomes the intelligent backup storage switch.

The functions of both intelligent primary storage controller and intelligent backup storage controller can be implemented in a SAN switch. The switch becomes the data protection storage switch.

The management station 104 of system 100 or the management station 204 of system 200 or a backup server map performs Object Backup. Object is a file or a collection of files or a bunch of data. One object can be divided into one or many elements. Each element can be different construct. Backup is done via full backup package, differential backup package, or incremental backup package. Backup data of differential backup package or incremental backup package can be one or many elements (partial or whole) of the object. Full backup package contains whole object. Backup package has its identification that contains version number. The device 108 or the device 214 maintains the management database to track versions and backup data that are pertinent to an object. The redundant backup data elimination can be performed in each element of the object or in a pre-defined granular unit, which is one sector or multiple sectors. Data mirroring or other RAID feature can be used to prevent management database from data loss.

Clearly, other embodiments and modifications of the present invention will occur readily to those of ordinary skill in the art in view of these teachings. Therefore, this invention is to be limited only by the following claims, which includes all such embodiments and modifications when viewed with conjunction with the above illustrative examples and accompanying figures.

1. In a computer system consists of management station, client computer, intelligent primary disk device and intelligent backup disk device.
Said intelligent primary disk device consists of intelligent primary storage controller and primary disk medium:
Said intelligent backup disk device consists of intelligent backup storage controller and backup disk medium.
The procedures of data backup and data restoration comprising:
Said management station issues a backup identification command along with a backup identification construct to said intelligent primary storage controller. A backup session in said intelligent primary storage controller is started.
Said management station issues a backup identification command along with said backup identification construct to said intelligent backup storage controller. A backup session in said intelligent backup storage controller is started.
Composition of backup identification construct includes (1) primary device identification, (2) primary recordable unit identification, (3) scope of backup, and (4) granular unit of backup data in sectors.
Said scope of backup is a contiguous storage area inside said primary recordable unit that is exclusively handled by said backup session.
Said granular unit in sectors is a cluster of data that is minimum recording unit will be handled by this backup processing.
Said intelligent primary storage controller is capable of performing full backup. Said full backup event is triggered by a full backup command along with a full backup construct from said management station to said intelligent primary storage controller. Said intelligent primary storage controller transfers a full backup package from said intelligent primary storage controller to said intelligent backup disk device. Said backup data in said full backup package is read from said primary disk medium by said intelligent primary storage controller.
Composition of full backup construct includes (1) primary device identification, (2) primary recordable unit identification, (3) scope of backup, (4) version, (5) full backup package type, and (6) write record
Composition of full backup package includes (1) primary device identification, (2) primary recordable unit identification, (3) scope of backup, (4) version, (5) full backup package type, (6) write record, and (7) backup data.
Item (1) through item (6) of said composition of full backup package are identical to item (1) through item (6) of said composition of full backup construct.
Item (1) through item (3) of said composition of full backup construct are identical to item (1) through item (3) of said composition of backup identification construct.
Said version is version number that can be the time of backup processing or a unique number.
Said write record is a description of the locations of backup data inside primary recordable unit. The information of said write record covers either only used granular units in scope of backup or whole volume of scope of backup.
Said intelligent backup storage controller is capable of restoring a versioned image of said primary disk medium by utilizing said full backup package in said backup disk medium. Said management station or client computer interprets said versioned image through file system software and provides said version of backup files and file directories.

2. The system and procedures as recited in claim 1, further comprising:
Said intelligent primary storage controller records all write operations to said primary disk medium on a write journal continuously between the last full backup and the ensuing differential backup. Said intelligent primary storage controller is capable of generating differential backup package which is triggered by a pre-set internal timer or a pre-set policy of said intelligent primary storage controller or by a differential backup command with a backup identification construct from said management station to said intelligent primary storage controller. Said intelligent storage controller converts information on said write journal to a write record. Said intelligent primary storage controller reads the backup data from said primary disk medium. Said intelligent storage controller transfers said differential backup package to said intelligent backup disk device.
The composition of said backup identification construct is cited in claim 1.
Composition of differential backup package includes (1) primary device identification, (2) primary recordable unit identification, (3) scope of backup, (4) version, (5) differential backup package type, (6) write record, and (7) backup data.
Said write record is a form of write journal at time of backup. Said write record is a description of the locations of backup data inside primary recordable unit. Said backup data is data in the granular units that have been updated since the last backup.
Said intelligent backup storage controller is capable of restoring a versioned image of said primary disk medium by utilizing said differential backup package of the specified version and the earlier said full backup package in said intelligent backup disk device.
Said intelligent backup storage controller records the relationship of the location information of stored backup data in said backup disk medium and the location information of backed up data in said primary disk medium in a database. Said location information of backed up data in said primary disk medium is derived from said full backup package and said differential backup packages. Said database is resided at said backup disk medium. Said intelligent backup storage controller utilizes data mirroring or other RAID features to prevent database from data loss. Said intelligent backup storage controller performs data comparison on backup data between said full backup and said differential backup in said granular unit. If an identical backup data is detected, said intelligent backup storage controller eliminated the new backup data and the new database entry to the database.
Said management station or client computer interprets said versioned image through file system software and provides said version of backup files and file directories.

3. The system and procedures as recited in claim 1, further comprising:
Said intelligent storage controller records all write operations to said primary disk medium on a write journal continuously between the last backup and the ensuing incremental backup. Said intelligent storage controller is capable of generating incremental backup package which is triggered by a pre-set internal timer or a pre-set policy of said intelligent storage controller or by a incremental backup command with a backup identification construct from said management station to said intelligent storage controller. Said intelligent storage controller converts information of write journal to a write record. Said intelligent primary storage controller reads the backup data from said primary disk medium. Said intelligent storage controller transfers said incremental backup package to said intelligent backup disk device.
The composition of said backup identification construct is cited in claim 1.
Composition of incremental backup package includes (1) primary device identification, (2) primary recordable unit identification, (3) scope of backup, (4) version, (5) incremental backup package type, (6) write record, and (7) backup data.
Said write record is a form of write journal at time of backup. Said write record is a description of the locations of backup data inside primary recordable unit. Said backup data is data in the granular units (e.g. sectors, clusters) that have been updated since the last backup. The last backup can be a full backup or an incremental backup.
Said intelligent backup storage controller is capable of restoring a versioned image of said primary disk medium by utilizing the earlier said full backup package and all incremental backup packages up to the version, that have been received by said intelligent backup disk device since the earlier full backup package was received.
Said intelligent backup storage controller records the relationship of the location information of stored backup data in said backup disk medium and the location information of backed up data in said primary disk medium in a database. Said location information of backed up data in said primary disk medium is derived from said full backup package and said incremental backup packages. Said database is resided at said backup disk medium. Said intelligent backup storage controller utilizes data mirroring or other RAID features to prevent database from data loss. Said intelligent backup storage controller performs data comparison on backup data between different backup versions in said granular unit. If an identical backup data is detected, said intelligent backup storage controller eliminated the new backup data and the new database entry to the database.
Said management station or client computer interprets or client computer said versioned image through file system software and provides said version of backup files and file directories.

4. In a computer system consists of management station, client computer intelligent primary disk device and intelligent backup disk device.
Said intelligent primary disk device consists of intelligent primary storage controller and primary disk medium.
Said intelligent backup disk device consists of intelligent backup storage controller and backup disk medium.
The procedures of data backup and data restoration comprising:
Said management station issues a backup identification command along with a backup identification construct to said intelligent primary storage controller. A backup session in said intelligent primary storage controller is started.
Said management station issues a backup identification command along with said backup identification construct to said intelligent backup disk device. A backup session in said intelligent backup storage controller is started.
Said management station issues a standalone backup command along with a full backup construct to said intelligent primary storage controller at any time after said backup sessions have started. Said intelligent primary storage controller transfers a standalone backup package to said intelligent backup disk device. Said intelligent primary storage controller reads the backup data from said primary disk medium. Standalone command is used to backup any data within a storage region that is specified in said scope of backup in said full backup construct.
The compositions of backup identification construct and full backup construct are cited in claim 1.
Composition of standalone backup package includes (1) primary device identification, (2) primary recordable unit identification, (3) scope of backup, (4) version, (5) standalone backup package type, (6) write record, and (7) backup data.
Said intelligent backup storage controller is capable of restoring a versioned image of said primary disk medium by utilizing said standalone backup package. Said management station or client computer interprets said versioned image through file system software and provides said version of backup files and file directories.

5. In a computer system consists of management station, client computer and intelligent backup disk device.
Said intelligent backup disk device consists of intelligent backup storage controller and backup disk medium.
The procedures of data backup and data restoration comprising:
Said management station issues a backup identification command along with a backup identification construct to said intelligent backup storage controller. A backup session in said intelligent backup storage controller is started.
Said management station transfers a standalone package to said intelligent backup disk device. Said standalone package can be a disk partition image of a local disk in a client computer.
The composition of backup identification construct is cited in claim 1. The composition of standalone backup package is cited in claim 4
Said intelligent backup storage controller is capable of restoring a versioned image by utilizing said standalone backup package. Said management station or client computer interprets said versioned image through file system software and provides said version of backup files and file directories.

6. In a computer system consists of management station, client computer and intelligent backup disk device.
Said intelligent backup disk device consists of intelligent backup storage controller and backup disk medium.
The procedures of data backup and data restoration comprising:
Said management station issues a backup identification command along with a backup identification construct to said intelligent backup storage controller. A backup session in said intelligent backup storage controller is started.
Said management station transfers a full backup package to said intelligent backup disk device. Later said management station transfers a differential full backup package to said intelligent backup disk device.
The compositions of said backup identification and said full backup package are cited in claim 1. The composition of said differential backup package is cited in claim 2.
Said intelligent backup storage controller is capable of restoring a versioned image by utilizing said differential backup package of the specified version and the earlier said full backup package.
Said intelligent backup storage controller records the relationship of the location information of stored backup data in said backup disk medium and the location information of backed up data in said primary disk medium in a database. Said location information of backed up data in said primary disk medium is derived from said full backup package and said differential backup packages. Said database is resided at said backup disk medium. Said intelligent backup storage controller utilizes data mirroring or other RAID features to prevent database from data loss. Said intelligent backup storage controller performs data comparison on backup data between said full backup and said differential backup in said granular unit. If an identical backup data is detected, said intelligent backup storage controller eliminated the new backup data and the new database entry to the database.
Said management station or client computer interprets said versioned image through file system software and provides said version of backup files and file directories.

7. In a computer system consists of management station, client computer and intelligent backup disk device.
Said intelligent backup disk device consists of intelligent backup storage controller and backup disk medium
The procedures of data backup and data restoration comprising:
Said management station issues a backup identification command along with a backup identification construct to said intelligent backup disk device. A backup session in said intelligent backup storage controller is started.
Said management station transfers a full backup package to said intelligent backup disk device. Later said management station transfers a sequence of incremental packages to said intelligent backup disk device.
The compositions of said backup identification and said full backup package are cited in claim 1. The composition of said incremental backup package is cited in claim 3.
Said intelligent backup storage controller is capable of restoring a versioned image by utilizing the earlier said full backup package and all incremental backup packages up to the version that have been received by said intelligent backup disk device since the earlier full backup package was received.
Said intelligent backup storage controller records the relationship of the location information of stored backup data in said backup disk medium and the location information of backed up data in said primary disk medium in a database. Said location information of backed up data in said primary disk medium is derived from said full backup package and said incremental backup packages. Said database is resided at said backup disk medium. Said intelligent backup storage controller utilizes data mirroring or other RAID features to prevent database from data loss. Said intelligent backup storage controller performs data comparison on backup data between different backup versions in said granular unit. If an identical backup data is detected, said intelligent backup storage controller eliminated the new backup data and the new database entry to the database.
Said management station or client computer interprets said versioned image through file system software and provides said version of backup files and file directories.

8. Compositions of full backup package, differential backup package, incremental backup package, and standalone backup package have been defined in the previous claims. Other compositions to represent these backup packages can be readily developed. General form of these backup packages includes (1) identification (2) backup data, (3) location information of backup data in the primary disk medium.

9. The concept of a storage controller that is capable of assembling backup packages in response to a request of internal means. Internal means include internal timer or pre-defined policy.

10. The concept of a storage controller that is capable of assembling backup packages under request of external means. External means include in-band command or out-band command.

11. An intelligent primary storage controller can generate a full backup package in response to a request of internal means after a back up session has started. The backup data of said full backup package is the complete data that covers full volume of backup scope. The write record of said full backup package covers all sectors of backup scope.

12. In a computer system consists of backup server, intelligent primary disk device, and any type of backup medium.
Said intelligent primary disk device consists of intelligent primary storage controller and primary disk medium.
Said intelligent primary storage controller is capable of performing differential write record collection. Said intelligent primary storage controller records all write operations on a write journal continuously between starting of backup session and “retrieve differential write record” command. Said intelligent primary storage controller converts information of said write journal to a write record and sends said write record to said backup server upon receiving a “retrieve differential write record” command.
The procedures to retrieve said differential write record comprising:
Said backup server issues a backup identification command along with a backup identification construct to said intelligent primary storage controller. A backup session in said intelligent primary storage controller is started.
Said intelligent primary storage controller resets the write journal at the beginning of backup session.
Said backup server issues a “retrieve differential write record” command along with said backup identification construct to said intelligent primary storage controller for retrieving said differential write record. Said primary storage controller sends the differential write record package to said backup server.
Composition of differential write record package includes (1) primary device identification, (2) primary recordable unit identification, (3) scope of backup, (4) version, (5) differential write record package type, and (6) write record.
Said backup server utilizes said differential write record and performs a differential backup in image backup technique.
The technique, which described above, improves system performance in comparison with the technique that executes a resident software to monitor which parts of the disk volume have been updated in prior art. The present invention locates the monitoring mechanism in the right place. The benefit is much prominent for networked disk storage that is shared with many computer hosts.

13. Composition of differential write record package has been defined in the previous claim. Other compositions to represent this differential write record package can be readily developed. General form of this differential write record package includes (1) identification, and (2) location information of updated sectors in the primary disk medium between starting of backup session and “retrieve differential write record” command.

14. In a computer system consists of backup server, intelligent primary disk device, and any type of backup medium.
Said intelligent primary disk device consists of intelligent primary storage controller and primary disk medium.
Said intelligent primary storage controller is capable of performing incremental write record collection. Said intelligent primary storage controller records all write operations on a write journal continuously between the beginning of backup session and ensuing “retrieve incremental write record” command or between two consecutive “retrieve incremental write record” commands. Said intelligent primary disk device converts information of said write journal to a write record and sends said write record to said backup server upon receiving a “retrieve incremental write record” command.
The procedures to retrieve said incremental write record comprising:
Said backup server issues a backup identification command along with a backup identification construct to said intelligent primary storage controller. A backup session in said intelligent primary storage controller is started.
Said intelligent primary storage controller resets the write journal at the beginning of backup session or after performing “retrieve incremental write record” command.
Said backup server issues a “retrieve incremental write record” command along with said backup identification construct to said intelligent primary storage controller for retrieving said incremental write record. Said primary storage controller sends the incremental write record package to said backup server.
Composition of incremental write record package includes (1) primary device identification, (2) primary recordable unit identification, (3) scope of backup, (4) version, (5) incremental write record package type, and (6) write record.
Said backup server utilizes said incremental write record and performs an incremental backup in image backup technique.
The technique, which described above, improves system performance in comparison with the technique that executes a resident software to monitor which parts of the disk volume have been updated in prior art. The present invention locates the monitoring mechanism in the right place. The benefit is much prominent for networked disk storage that is shared with many computer hosts.

15. Composition of incremental write record package has been defined in the previous claim. Other compositions to represent this incremental write record package can be readily developed. General form of this incremental write record package includes (1) identification, and (2) location information of updated sectors in the primary disk medium between the beginning of backup session and ensuing “retrieve incremental write record” command or between two consecutive “retrieve incremental write record” commands.

16. The concept of a storage controller that is capable of producing a differential write records or incremental write records in response to commands from backup server. These write records eliminate resident software to monitor which parts of the disk volume have been updated in prior art. The present invention locates the monitoring mechanism in the right place. The benefit is much prominent for networked disk storage that is shared with many computer hosts.

17. The concept of a backup storage device that stores backup package, which contains backup data and the location information of said backup data in the primary storage device.

18. The concept of a backup storage device that maintains a database to track locations of said backup data stored in said backup storage device and locations of said backed up data in the primary storage device.

19. The concept of a backup storage device contains backup data and database.

20. The concept of a backup storage device contains backup data and database and performs redundant backup data elimination.

21. The concept of a backup storage device contains backup data and database and performs redundant backup data elimination in image backup technique.

22. The concept of a backup storage device that utilizes data mirroring or other RAID features to prevent database from data loss.

23. The concept of a backup storage device that utilizes backup data and database to reconstruct saved image of said primary storage device.

24. The concept of mounting as a read-only volume directly on a backup storage device by a client computer or management station.

25. Intelligent backup disk device contains multiple disk drives. Said intelligent backup disk device is capable of performing power management. Said intelligent backup disk device sets individual disk drive to a power level. Many different power levels can be devised such as fully active mode, standby mode, and power off mode.

26. The concept of implementing the functions of the intelligent primary storage controller in a SAN (Storage Area Network) switch. Said switch becomes the center of data backup.
The concept of implementing the functions of the intelligent backup storage controller in a SAN switch. Said switch becomes the center of data restoration.
The concept of implementing the functions of both intelligent primary storage controller and intelligent backup storage controller in a SAN switch. Said switch becomes the center of data protection.

27. The concept of a backup storage device contains backup data and database and performs redundant backup data elimination in object backup. Object is a file or a collection of files or a bunch of data. Object has its identification that contains version number. Backup storage device receives full backup packages, or differential backup packages, or incremental backup packages. Backup storage device has a database to track versions and backup data that are pertinent to an object. Each database entry in the database relates to an element of the object or a pre-defined granular unit of backup disk medium. The redundant backup data elimination can be performed in each element of the object or in a pre-defined granular unit, which is one sector or multiple sectors of backup disk medium. Data mirroring or other RAID feature can be used to prevent the database from data loss.
